(19) United States
(12) Patent Application Publication
(10) Pub. No.: US 2006/0294319 A1
(43) Pub. Date: Dec. 28, 2006

(54) Managing snoop operations in a data processing apparatus

(75) Inventor: David Hennah Mansell, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cherry Hinton (GB)

(21) Appl. No.: 11/454,834

(22) Filed: Jun. 19, 2006

(30) Foreign Application Priority Data
Jun. 24, 2005 (GB) 0512930.9

(51) Int. Cl. G06F 13/28

(52) U.S. Cl. 711/146

(57) ABSTRACT

A data processing apparatus and method are provided for managing snoop operations. The data processing apparatus comprises a plurality of processing units for executing a number of processes by performing data processing operations requiring access to data in shared memory. Each processing unit has a cache for storing a subset of the data for access by that processing unit, the data processing apparatus employing a snoop-based cache coherency protocol to ensure data access by each processing unit is up-to-date. Each processing unit has a storage element associated therewith identifying snoop control data, whereby when one of the processing units determines that a snoop operation is required having regard to the cache coherency protocol, that processing unit references the snoop control data in its associated storage element in order to determine which of the plurality of processing units are to be subjected to the snoop operation. This can give rise to significant energy savings by avoiding unnecessary cache tag look ups, and can also improve performance.

### BACKGROUND OF THE INVENTION

1. Field of the Invention

The present invention relates to the management of snoop operations in a data processing apparatus.

2. Description of the Prior Art

It is known to provide multi-processing systems in which two or more processing units, for example processor cores, share access to shared memory. Such systems are typically used to gain higher performance by arranging the different processor cores to execute respective data processing operations in parallel. Known data processing systems which provide such multi-processing capabilities include IBM370 systems and SPARC multi-processing systems. These particular multi-processing systems are high performance systems where power efficiency and power consumption is of little concern and the main objective is maximum processing speed.

To further improve speed of access to data within such a multi-processing system, it is known to provide each of the processing units with its own local cache in which to store a subset of the data held in the shared memory. Whilst this can improve speed of access to data, it complicates the issue of data coherency. In particular, it will be appreciated that if a particular processor performs a write operation with regards to a data value held in its local cache, that data value will be updated locally within the cache, but may not necessarily also be updated at the same time in the shared memory. In particular, if the data value in question relates to a write back region of memory, then the updated data value in the cache will only be stored back to the shared memory when that data value is subsequently evicted from the cache.

Since the data may be shared with other processors, it is important to ensure that those processors will access the up-to-date data when seeking to access the associated address in shared memory. To ensure that this happens, it is known to employ a cache coherency protocol within the multi-processing system to ensure that if a particular processor updates a data value held in its local cache, that up-to-date data will be made available to any other processor subsequently requesting access to that data.

One type of cache coherency protocol is a snoop-based cache coherency protocol. In accordance with such a protocol, certain accesses performed by a processor will require that processor to perform a snoop operation. The snoop operation will cause a notification to be sent to the other processors identifying the type of access taking place and the address being accessed. This will cause those other processors to perform certain actions defined by the cache coherency protocol, and may also in certain instances result in certain information being fed back from one or more of those processors to the processor initiating the snoop operation. By such a technique, the coherency of the data held in the various local caches is maintained, ensuring that each processor accesses up-to-date data. One such snoop-based cache coherency protocol is the “Modified, Exclusive, Shared, Invalid” (MESI) cache coherency protocol.

If a particular piece of data can be guaranteed to be exclusively used by only one of the processors, then that processor will not need to issue a snoop operation when accessing that data. However, in a typical multi-processing system, much of the data will be shared amongst the processors, either because the data is generally classed as shared data, or because the multi-processing system allows for the migration of processes between processors, or indeed for a particular process to be run in parallel on multiple processors, with the result that even data that is specific to a particular process cannot be guaranteed to be exclusively used by a particular processor.

Given the above situation, in known multi-processing systems, when a particular processor determines that a snoop operation is required having regards to the cache coherency policy, all of the other processors are subjected to the snoop operation. Each of the other processors will hence consume energy performing cache tag lookups required by the snoop operation, in order to determine if their local cache contains a copy of the data value at the address being accessed. Further, these cache tag lookups may affect performance of the multi-processing system, since it may be the case that the processor has to halt what it is currently doing in order to perform the required cache tag lookup. Since all of the other processors will be subjected to the snoop operation even if in fact they are not affected by the data access causing the snoop operation to take place (either because they do not have access to that data address, or have not cached the data at that data address in their local cache), then it will be appreciated that the energy consumption and performance impact resulting from a particular processor being subjected to the snoop operation will serve no useful purpose if that particular processor is not affected by the data access in question (the result of such a snoop operation being referred to herein as a snoop miss).

Accordingly, it would be desirable to provide an improved technique for more efficiently managing snoop operations in a data processing apparatus.

### SUMMARY OF THE INVENTION

Viewed from the first aspect, the present invention provides a data processing apparatus comprising: a plurality of processing units operable to execute a number of processes by performing data processing operations requiring access to data in shared memory; each processing unit having a cache operable to store a subset of said data for access by that processing unit, the data processing apparatus employing a snoop-based cache coherency protocol to ensure data accessed by each processing unit is up-to-date; each processing unit having a storage element associated therewith identifying snoop control data; whereby when one of said processing units determines that a snoop operation is required having regard to the cache coherency protocol, that processing unit is operable to reference the snoop control data in the associated storage element in order to determine which of the plurality of processing units are to be subjected to the snoop operation.

In accordance with the present invention, each processing unit has a storage element associated therewith, which may for example take the form of a register, this storage element identifying snoop control data. Then, when one of the processing units determines that a snoop operation is required having regard to the cache coherency protocol, that processing unit is operable to reference the snoop control data in the associated storage element in order to determine which of the plurality of processing units are to be subjected to the snoop operation. Snoop control data can hence be specified on a processing unit by processing unit basis, so as to control which processing units are subjected to a snoop operation instigated by a particular processing unit. It has been found that such an approach can result in significant energy savings, through the reduction in snoop misses that would otherwise result from unnecessary cache tag lookups, and can also improve overall performance of the data processing apparatus.

The snoop control data can take a variety of forms. In one embodiment, the data processing apparatus further comprises: process descriptor storage for storing a process descriptor for each process, the process descriptor being operable to identify any processing units of said plurality that the corresponding process has been executed on; and for each processing unit, the snoop control data in the associated storage element being dependent on the process currently being executed by that processing unit. If a processor has executed a particular process, then that processor's cache may contain data relating to that process, whereas if a processor has not executed that particular process then that processor's cache cannot contain data relating to that process.

Hence, in such embodiments, the snoop control data associated with a particular processing unit varies depending on the process currently being executed by that processing unit. Hence, by way of example, if process one is being executed on processor A, and the process descriptor for process one identifies that only processor A and processor B of the multi-processing system have executed process one, then the snoop control data stored in the storage element associated with processor A will identify that only processor B needs to be subjected to the snoop operation if such a snoop operation is instigated by processor A.

The process descriptor storage can take a variety of forms. However, in one embodiment, the process descriptor storage is formed by a region of the shared memory.

The process descriptor can be specified in a variety of ways. However, in one embodiment, the process descriptor includes a mask, the mask having N bits, where N is the number of processors in the multi-processing system, and each bit of the mask is set if the associated processor has executed the process.

In such embodiments, the snoop control data can be specified by merely replicating in a processor's storage element the mask provided by the process descriptor of the process that that processor is currently executing.

When a new thread of a process is created on a particular processor, or an existing thread of a process is switched from one processor to another, an issue arises concerning the updating of snoop control data stored in the storage elements of any other processing units running that process. In one embodiment, if a processing unit undertakes execution of a process currently being executed by at least one other processing unit, the processing unit causes the process descriptor for that process to be updated and issues an update signal to each of the at least one other processing units, each of the at least one other processing units being operable in response to the update signal to update the snoop control data in its associated storage element based on the updated process descriptor. Hence, by this approach, the snoop control data on any other relevant processing units is caused to be updated by reference to the updated process descriptor stored in the process descriptor storage.

The update signal can take a variety of forms. However, in one embodiment the update signal is an interrupt signal. In one particular embodiment the interrupt signal takes the form of an Inter Processor Interrupt (IPI) issued by the processing unit that is undertaking execution of a process currently being executed by at least one other processing unit.

In one embodiment, the shared memory can be considered to comprise a number of regions. In particular, in one embodiment, each process has associated therewith in the shared memory a process specific region in which data only used by that process is storable, and each processing unit is operable, when accessing data, to determine if the snoop operation is required having regard to the cache coherency protocol, and if the snoop operation is required and the data being accessed is associated with the process specific region, to reference the snoop control data in the associated storage element in order to determine which of the plurality of processing units are to be subjected to the snoop operation. Hence, in accordance with this embodiment, the snoop control data is referenced when managing snoop operations pertaining to data in a process specific region of shared memory.

In one embodiment, each process is arranged to have access to a shared region in the shared memory in which data to be shared amongst multiple processes is stored, and each processing unit is operable, when accessing data, to determine if the snoop operation is required having regard to the cache coherency protocol, and if the snoop operation is required and the data being accessed is associated with the shared region, to subject all of the plurality of processing units to the snoop operation.

In one embodiment, the shared memory has one or more shared regions and one or more process specific regions.

The process descriptors can be managed in a variety of ways. However, in one embodiment, the process descriptor for each process is managed by operating systems software. In one such embodiment, the operating system software is operable, for each process descriptor, to apply predetermined criteria to determine when a processing unit that has executed the corresponding process should cease to be identified in that process descriptor, upon such a determination, any entries in the cache of that processing unit storing data relating to the corresponding process being cleaned and invalidated, and the process descriptor being updated by the operating system software to remove the identification of that processing unit. Hence, such a process can be used to update processor descriptors as and when appropriate having regards to the predetermined criteria in order to ensure that no more processing units than necessary are subjected to snoop operations. In particular, in one embodiment, the predetermined criteria is some form of timing criteria, such that for example if a particular processor has not executed a process for a predetermined length of time, the reference to that processor is removed from the process descriptor of that process. At the same time, any entries in the cache of that processor storing data relating to the process are cleaned and invalidated, to ensure that any dirty and valid data in that cache and pertaining to that process is written back to the shared memory.

Optionally, when using the operating system to modify the process descriptors in such a way, the operating system can be arranged to cause any processing units currently executing the corresponding process to be advised of the update, so that their snoop control data can be updated accordingly. If their snoop control data is not updated, this will merely mean that the processing unit that has ceased to be identified in the process descriptor may be subjected to some unnecessary snoop operations.

Viewed from the second aspect, the present invention provides a method of managing snoop operations in a data processing apparatus, the data processing apparatus having a plurality of processing units operable to execute a number of processes by performing data processing operations requiring access to data in shared memory, each processing unit having a cache operable to store a subset of said data for access by that processing unit, the method comprising the steps of: employing a snoop-based cache coherency protocol to ensure data accessed by each processing unit is up-to-date; for each processing unit storing snoop control data; and when one of the processing units determines that a snoop operation is required having regard to the cache coherency protocol, referencing the snoop control data for said one of the processing units in order to determine which of the plurality of processing units are to be subjected to the snoop operation.

Viewed from a third aspect, the present invention provides a processing unit for a data processing apparatus in which a plurality of processing units are operable to execute a number of processes by performing data processing operations requiring access to data in shared memory, the processing unit comprising: a cache operable to store a subset of said data for access by the processing unit, a snoop-based cache coherency protocol being employed to ensure data accessed by each processing unit of the data processing apparatus is up-to-date; a storage element identifying snoop control data; whereby when the processing unit determines that a snoop operation is required having regard to the cache coherency protocol, the processing unit is operable to reference the snoop control data in the storage element in order to determine which of the plurality of processing units of the data processing apparatus are to be subjected to the snoop operation.

### DESCRIPTION OF THE DRAWINGS

The present invention will be described further, by way of example only, with reference to an embodiment thereof as illustrated in the accompanying drawings, in which:

FIG. 1 is a block diagram of a data processing apparatus in accordance with one embodiment of the present invention;

FIG. 2 is the diagram schematically illustrating a snoop-based cache coherency protocol that may be employed within the processors of FIG. 1;

FIG. 3 is a flow diagram illustrating steps taken to set a CPU mask within a processor when starting a new process in accordance with one embodiment of the present invention;

FIG. 4 is a flow diagram illustrating steps performed in accordance with one embodiment of the present invention when starting a new thread or performing a process switch;

FIG. 5 is a flow diagram illustrating the steps performed when handling an inter processor interrupt in accordance with one embodiment of the present invention;

FIG. 6 is a flow diagram illustrating steps performed in one embodiment of the present invention when removing a reference to a particular processor from a process mask; and

FIG. 7 is a flow diagram illustrating steps performed by a processor in accordance with one embodiment of the present invention when instigating a snoop operation.

### DESCRIPTION OF EMBODIMENTS

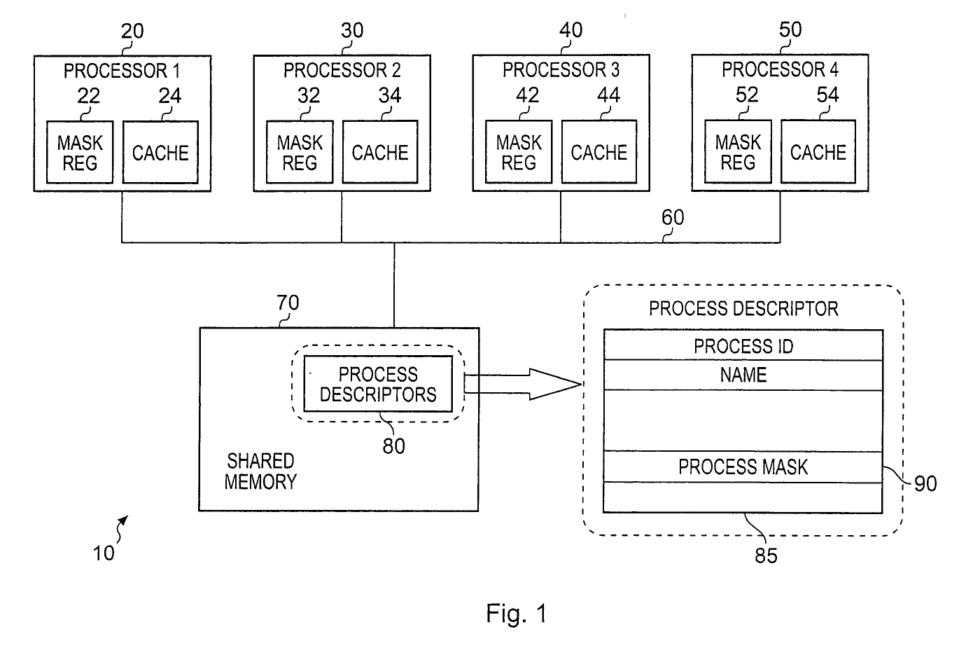

FIG. 1 is a block diagram of a data processing apparatus 10 comprising multiple processors 20, 30, 40, 50 which are coupled via a bus 60 with a shared memory region 70. Each of the processors 20, 30, 40, 50 has an associated local cache 24, 34, 44, 54, respectively, in which it can store a subset of the data held in the shared memory in order to increase speed of access to that data via the processor.

In accordance with the embodiment of the invention shown in FIG. 1, each processor 20, 30, 40, 50 also has provided therein a mask register 22, 32, 42, 52, respectively, which is used to store snoop control data for use by that processor when instigating snoop operations. In one embodiment, the snoop control data takes the form of a mask comprising a separate bit for each processor of the data processing apparatus, and accordingly in the example of FIG. 1 the mask comprises four bits. Each bit of the mask is associated with a particular processor. At any point in time, the mask data stored in the mask register is dependent on the process being executed by the associated processor and hence for example if the processor one 20 is executing process X, then the mask register 22 will contain mask data appropriate for process X. In particular, each individual bit of the mask will be set if the processor associated with that bit has run process X. Hence, assuming that a logic 1 value indicates a set state of a mask bit and a logic zero value indicates a clear state of a mask bit, a mask value of “0011” (the first bit associated with processor 4, the next bit with processor 3, the next bit with processor 2, and the last bit with processor 1) stored in mask register 22 of processor one 20 will indicate that processor two 30 has run, or is currently running, the process being executed by processor one 20, but processors three and four 40, 50 have not run that process (at least within the time frame upon which the mask data is based).

The data processing apparatus 10 employs a snoop-based cache coherency protocol, such that when a processor makes certain types of data accesses, a snoop operation is required to be instigated by that processor. With reference to the above example, if processor one 20 determines as a result of that cache coherency protocol that a snoop operation is required, only processor two 30 will need to be subjected to the snoop operation, and processors three and four 40, 50 do not need to be subjected to the snoop operation, given the mask value of “0011” in mask register 22.

As shown in FIG. 1, a portion of the shared memory 70 is used as process descriptor storage 80 to store process descriptors providing certain information about each of the processes being executed on the data processing apparatus 10. As shown in the right-hand side of FIG. 1, each individual process descriptor 85 will contain a number of fields identifying certain parameters of the process, for example the process ID, the process name, etc. In addition, in accordance with embodiments of the present invention, a process mask 90 is stored within the process descriptor identifying those processors that have executed that process. In one embodiment, the process mask contains a bit for each processor 20, 30, 40, 50, which is set if that processor has run the associated process. The process descriptors are maintained by the operating system used by the data processing apparatus 10, and the mask stored in each mask register 22, 32, 42, 52 is set in dependence on the process mask of the process being executed by the processor in which that mask register resides.

For processes that are relatively short lived, the operating system may be arranged to merely update the process mask each time a new thread of that process is initiated on a different processor, or each time a process is migrated from one processor to another, without any set bits of the mask ever being cleared. However, for longer lasting processes, it is possible that such an approach will adversely affect the effectiveness of the embodiment of the present invention in reducing processing units being subjected unnecessarily to snoop operations, particularly where processes are migrated from one processor to another over time.

As a particular example, consider the situation where process X is initially run on processor one 20, but over time is migrated to processor two 30, then to processor three 40, and then to processor four 50. By the time the process has been migrated to processor four 50, all of the bits of the process mask 90 will be set. Accordingly, the mask stored within the mask register 52 of processor four 50 will have all bits set, and accordingly if the processor four 50 determines that a snoop operation is required, it will need to subject all of the other processors 20, 30, 40 to that snoop operation.

Such a scenario may occur in practice relatively infrequently, such that it does not prove problematic. However, if it is considered that such a scenario may occur often enough to be problematic, then it is possible to arrange the operating system software such that it applies predetermining criteria in order to determine when a processor that has executed a particular process should cease to be identified in the corresponding process descriptor. In particular, the predetermined criteria may be time based, such that for the process in question, if a particular processor has not executed that process for some predetermined timeout period, then the operating system software causes the process mask to be updated to remove the reference to that processor. At the same time, it will be necessary to clean and invalidate any entries in the cache of that processor that have been used to store data relating to the process in question. Such cleaning and invalidation procedures will be well known to those skilled in the art, and in particular it will be appreciated that the aim of such a procedure is to ensure that any dirty and valid data in the cache in question is written back to the shared memory 70 prior to the cache lines in question being marked as invalid.

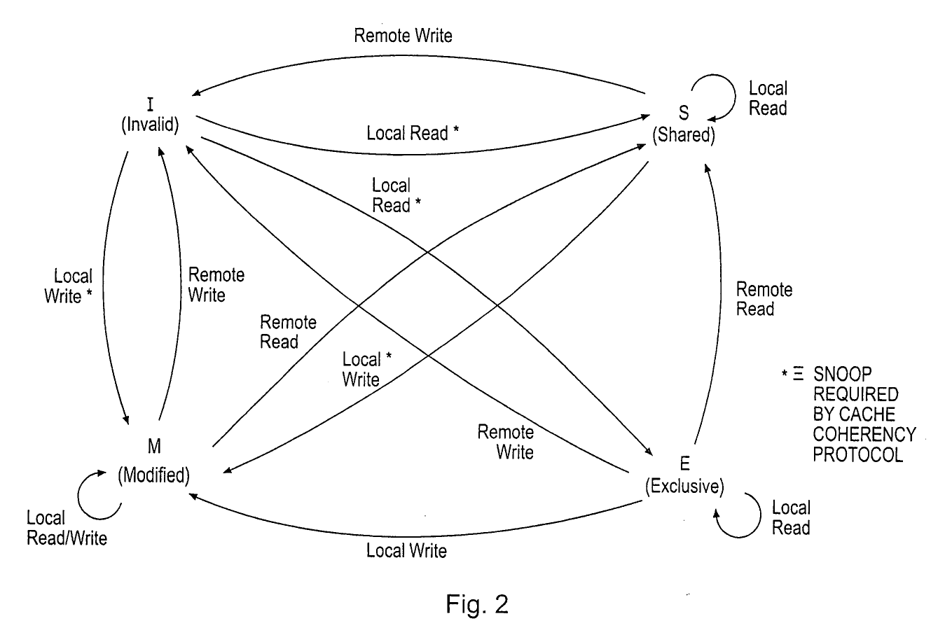

FIG. 2 is a state transition diagram illustrating a particular type of snoop-based cache coherency protocol called the MESI cache coherency protocol, and in one embodiment the MESI cache coherency protocol is used within the data processing apparatus 10 of FIG. 1. As shown in FIG. 2, each cache line of a cache can exist in one of four states, namely an I (invalid) state, an S (shared) state, an E (exclusive) state or an M (modified) state. The I state exists if the cache line is invalid, the S state exists if the cache line contains data also held in the caches of other processors, the E state exists if the cache line contains data not held in the caches of other processors, and the M state exists if the cache line contains modified data.

FIG. 2 shows the transitions in state that may occur as a result of various read or write operations. A local read or write operation is a read or write operation instigated by the processor in which the cache resides, whereas a remote read or write operation results from a read or write operation taking place on one of the other processors of the data processing apparatus issuing a snoop request.

It should be noted from FIG. 2 that a number of read and write activities do not require any snoop operation to be performed, but there are a certain number of read and write activities which do require a snoop operation to be performed. In particular, if the processor in which the cache resides performs a local read operation resulting in a cache miss, this will result in a line fill process being performed to a particular cache line of the cache, and the state of the cache line will then change from having the I bit set to having either the S or the E bit set. In order to decide which of the S bit or E bit should be set, the processor needs to instigate a snoop operation to any other processors that may have locally cached data at the address in question and await the results of that snoop operation before selecting whether to set the S bit or the E bit. If none of the other processors that could have cached the data at the address in question have cached the data, then the E bit can be set, whereas otherwise the S bit should be set. It should be noted that if the E bit is set, and then another processor subsequently performs a local read to its cache in respect of data at the same address, this will be viewed as a remote read by the cache whose E bit had previously been set, and as shown in FIG. 2 will cause a transition to occur such that the E bit is cleared and the S bit is set.

As also shown in FIG. 2, a local write process will result in an update of a data value held in the cache line of the cache, and will accordingly cause the M bit to be set. If the setting of the M bit occurs as a transition from either a set I bit (in the event of a cache miss followed by a cache line allocate, and then the write operation) or a transition from the set S bit state, then again a snoop operation needs to be instigated by the processor. In this instance, the processor does not need to receive any feedback from the processors being snooped, but those processors need to take any required action with respect to their own caches, where the write will be viewed as a remote write procedure. It should be noted that in the event of a local write in a cache line whose E bit is set, then the E bit can be cleared and the M bit set without instigating any snoop operation, since it is known that at the time the write was performed, the data at that address was not cached in the caches of any of the other processors.

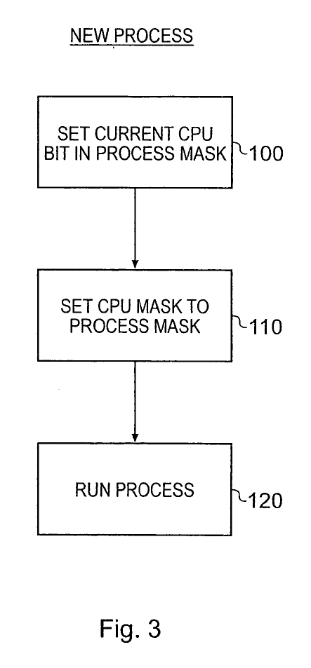

Whilst the MESI cache coherency protocol discussed with reference to FIG. 2 is a known cache coherency protocol, the problem that existed in prior art multi-processor systems was that when a snoop operation was required, all of the other processors had to be subjected to the snoop operation, which resulted in an increase in energy consumption, and a potential adverse effect on performance. Whilst such energy consumption and adverse performance are a necessary side effect with regards to those processors that have cached the data in question, and hence require the snoop operation in order to maintain cache coherency, such energy consumption and adversely affected performance is wasted with respect to any processors that did not in fact require the snoop operation, either because they have not locally cached the data, or because the process being executed on them could not in any case have access to the data in question, and hence could never have cached the data. The embodiment of the present invention described herein aims to alleviate such energy consumption and adverse performance impacts through a more selective choice as to which processors are subjected to any required snoop operation. The manner in which this is achieved is described below with reference to the flow diagrams of FIGS. 3 to 7.

FIG. 3 is a flow diagram illustrating some steps performed when a new process is first executed on a processor. At step 100, the CPU bit in the process mask associated with the processor on which the process is to be executed is set, as discussed earlier this typically being performed by the operating system software. Thereafter, as step 110, the CPU mask in the mask register of the processor that is going to execute the process is set equal to the process mask value. Thereafter, at step 120, the process is run on the processor. It will be appreciated that FIG. 3 does not show all of the steps that need to be taken when setting up a new process for execution, but instead is intended only to illustrate the steps involved in updating the process mask, followed by the corresponding update to the CPU mask in the mask register of the relevant processor.

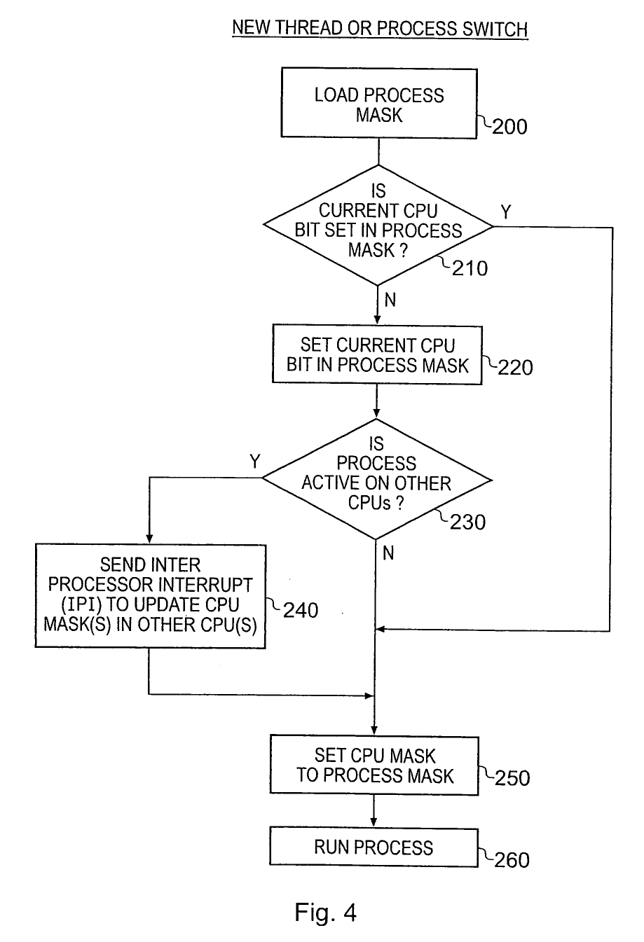

Once a new process has started to be executed, it is possible that a further thread of that process may be established on a different processor and/or execution of the process may be switched from one processor to another. FIG. 4 illustrates steps performed by the data processing apparatus 10 when either of these scenarios occurs. At step 200, the process mask 90 within the process descriptor 85 of the process in question is loaded into the processor that is to run the new thread or that is to run the thread being switched from another processor. This process mask will typically be loaded into one of the working registers of the processor. Then, at step 210 it is determined whether the current CPU bit is set in the process mask, i.e. whether the bit of the process mask corresponding to the processor on which the new thread is to be run, or the switched thread is to be run, is set. If the current CPU bit is set in the process mask, then the process proceeds directly to step 250 where the CPU mask in the mask register of the processor is set equal to the current process mask value, whereafter the process is then run on that processor at step 260.

However, if the current CPU bit is not set in the process mask at step 210, then the process proceeds to step 220, where the current CPU bit is set in the process mask. Thereafter, at step 230, it is determined whether the process is active on any other CPUs, i.e. on any of the other processors 20, 30, 40, 50 shown in FIG. 1. If not, then the process proceeds directly to step 250 to cause the CPU mask to be set equal to the current process mask, whereafter the process is run at step 260. However, if the process is active on any other CPUs, then the process branches to step 240, where an Inter Processor Interrupt (IPI) is sent to each other processor on which the process is active in order to cause those processors to update their CPU masks to reflect the update that occurred in the process mask at step 220. Details as to which processes are being run on each processor will typically be maintained within the shared memory 70, and accordingly the information will be available to the processor to enable it to make the required determination at step 230.

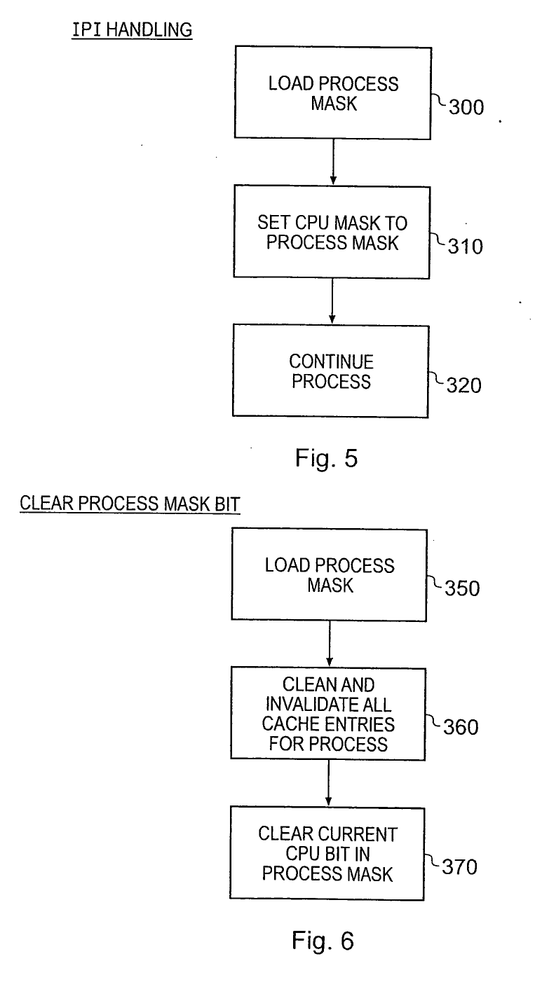

The manner in which a processor receiving an IPI handles that IPI is illustrated in the flow diagram of FIG. 5. In particular, on receiving the IPI, that processor will load the process mask into one of its working registers, whereafter at step 310 it will set the CPU mask in its mask register equal to the current value of the process mask. Thereafter, the processor will continue execution of the process at step 320.

As described earlier with reference to FIG. 4, process masks provided in the process descriptors associated with particular processes are updated at step 220 each time a new thread is created on a processor that has not previously executed a thread of that process, or each time the process is switched to a processor that has not previously executed that process. For processes that are relatively short-lived, it is likely that the information in the process mask will still enable significant energy and performance savings to be realised by avoiding processors being unnecessarily subjected to snoop operations. However, for longer lasting processes, it is possible over time that all bits of the process mask will become set, thereby avoiding the possibility of achieving any such energy or performance savings. If it transpires that such a situation may occur unacceptably frequently, then the operating system software can be arranged to apply predetermined criteria in order to determine situations where mask bits associated with particular processors can be cleared from the process mask of a particular process.

In particular, by way of example, timing based criteria can be used, such that if a particular processor has not executed a process for some finite length of time, then the corresponding bit in the process mask of the process descriptor associated with that process can be cleared. The process performed when it is decided to clear a bit in the process mask is illustrated schematically in FIG. 6. In particular, at step 350, the process mask for the processing question is loaded into a working register of the processor whose associated CPU bit is to be cleared. Then, at step 360, any cache entries in the cache of that processor that contain data relating to the process in question are cleaned and invalidated. As a result, any dirty and valid data in that cache (relating to the process in question) will be stored back to the relevant address(es) in shared memory 70. Thereafter, at step 370, the current CPU bit in the process mask is cleared, and the revised process mask is written back to memory.

Since the process mask of the process descriptor is shared between processors, it must be protected from concurrent updates by different processors, for example through use of a protecting lock providing mutual exclusion amongst the processors, or by use of atomic set/clear bit operations to update bits of the bit mask.

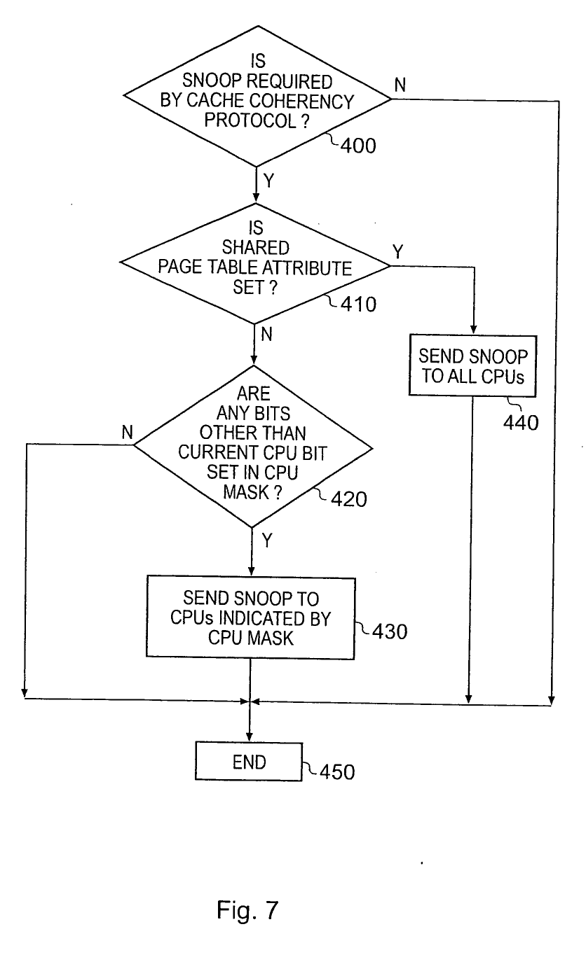

FIG. 7 is a flow diagram illustrating the steps performed in order to manage snoop operations in accordance with one embodiment of the present invention. At step 400, a processor decides, when accessing a data value at a particular address, whether a snoop operation is required having regards to the cache coherency policy, this having been discussed earlier with reference to FIG. 2. If it is not, then no further action is required and the process ends at step 450. However, assuming it is determined that a snoop operation is required having regards to the cache coherency protocol, then the process proceeds to step 410, where it is determined whether a shared page table attribute is set. Access to memory is controlled by page tables associated with particular memory regions, the page tables for example identifying virtual to physical address translations, access permissions, etc. Each page table will also have a shared page table attribute.

In one embodiment of the present invention, the shared memory is arranged into a number of regions, and in particular one or more shared regions may be identified in which data to be shared amongst multiple processes is stored. Further, one or more process specific regions may be identified such that data stored in a process specific region is only accessible by that particular process. If the address being accessed relates to data in a shared region, then the shared page table attribute will have been set in the associated page table, and accordingly the process will branch to step 440, where the snoop is sent to all other processors in the data processing apparatus 10.

However, if the shared page table attribute is not set, due to the fact that the data address is in a process specific region of the shared memory, then at step 420 it is determined whether any bits other than the current CPU bit are set in the CPU mask stored in the mask register of the processor. If not, then no action is required and the process ends at step 450. However, if there are other bits set, then the process proceeds to step 430, where the snoop is sent to all other processors indicated by set bits in the CPU mask. Thereafter, the process ends at step 450.

If instead of using the CPU masks of embodiments of the present invention as described above, it was instead decided to rely purely on the setting of the shared page table attribute to determine whether snooping should take place, this results in several difficulties. In particular, even though initially a particular page table may be specific to a process being run on a single processor, as soon as a thread is spawned on another processor, or the process itself is migrated to another processor, then it would be necessary to set the shared page table attribute in any affected page table. Since there are potentially multiple affected page tables, this can be quite complex and time consuming, and as a result in such systems it would be simpler to set the shared page table attribute at the outset. However, this then results in all snoop operations having to be propagated to all other processors (i.e. via a step analogous to step 440 in FIG. 7).

In accordance with the embodiment of the present invention, due to the use of the process mask in the process descriptor, along with the use of that process mask to then set CPU masks in the mask registers of individual processors, then when a new thread of a process is spawned on a different processor, or the process migrates from one processor to another, all that is required is for the appropriate bit in the process mask to be set and this update is then reflected in the relevant mask registers of the individual processors. Accordingly, there are more instances where the shared page table attribute can be left cleared and hence a significant number of snoop operations can proceed via steps 410, 420, 430 of FIG. 7, rather than needing to go via step 440, resulting in significant energy consumption reductions and avoidance of any associated adverse performance impacts that may arise from unnecessary snooping of particular processors.

From the above description of embodiments of the present invention, it will be seen that such embodiments make use of software knowledge of which memory regions have been used on which processors to restrict the scope of snoop requests to specific processors, thus reducing the wasted energy. This should be contrasted with existing schemes where snoop requests are indiscriminately broadcast to all processors.

Another advantage of embodiments of the present invention is that the hardware required to implement the technique is very cheap, since it is merely required to provide a mask register in each of the processors and to provide a process mask within each process descriptor. Indeed, in some implementations, such a process mask may already be provided for different reasons, and hence the only real addition required is the provision of the mask registers within each of the processors.

As discussed above, an embodiment of the present invention employs a new register in each processor which allows the operating system to indicate which processors in the system the currently employed process is running on or has previously been run on. The operating system also uses the existing shared page table attribute to indicate which pages are private to this process and which are shared with other processes. Thus, when performing snoop requests for areas of memory private to the current process, the processor can reference the register to ensure that snoop requests are only sent to those processors whose caches might contain the data in question, thus eliminating wasted tag look ups in those caches which the operating system knows in advance do not contain the data being accessed.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

I claim:

1. A data processing apparatus comprising:
a plurality of processing units operable to execute a number of processes by performing data processing operations requiring access to data in shared memory;
each processing unit having a cache operable to store a subset of said data for access by that processing unit, the data processing apparatus employing a snoop-based cache coherency protocol to ensure data accessed by each processing unit is up-to-date;
each processing unit having a storage element associated therewith identifying snoop control data;
whereby when one of said processing units determines that a snoop operation is required having regard to the cache coherency protocol, that processing unit is operable to reference the snoop control data in the associated storage element in order to determine which of the plurality of processing units are to be subjected to the snoop operation.

2. A data processing apparatus as claimed in claim 1, further comprising:
process descriptor storage for storing a process descriptor for each process, the process descriptor being operable to identify any processing units of said plurality that the corresponding process has been executed on; and
for each processing unit, the snoop control data in the associated storage element being dependent on the process currently being executed by that processing unit.

3. A data processing apparatus as claimed in claim 2, wherein if a processing unit undertakes execution of a process currently being executed by at least one other processing unit, the processing unit causes the process descriptor for that process to be updated and issues an update signal to each of the at least one other processing units, each of the at least one other processing units being operable in response to the update signal to update the snoop control data in its associated storage element based on the updated process descriptor.

4. A data processing apparatus as claimed in claim 3, wherein the update signal is an interrupt signal.

5. A data processing apparatus as claimed in claim 1, wherein:
each process has associated therewith in the shared memory a process specific region in which data only used by that process is storable; and
each processing unit is operable, when accessing data, to determine if the snoop operation is required having regard to the cache coherency protocol, and if the snoop operation is required and the data being accessed is associated with the process specific region, to reference the snoop control data in the associated storage element in order to determine which of the plurality of processing units are to be subjected to the snoop operation.

6. A data processing apparatus as claimed in claim 1, wherein:
each process is arranged to have access to a shared region in the shared memory in which data to be shared amongst multiple processes is stored; and
each processing unit is operable, when accessing data, to determine if the snoop operation is required having regard to the cache coherency protocol, and if the snoop operation is required and the data being accessed is associated with the shared region, to subject all of the plurality of processing units to the snoop operation.

7. A data processing apparatus as claimed in claim 2, wherein:
the process descriptor for each process is managed by operating system software;
the operating system software is operable, for each process descriptor, to apply predetermined criteria to determine when a processing unit that has executed the corresponding process should cease to be identified in that process descriptor;
upon such a determination, any entries in the cache of that processing unit storing data relating to the corresponding process being cleaned and invalidated, and the process descriptor being updated by the operating system software to remove the identification of that processing unit.

8. A data processing apparatus as claimed in claim 1, wherein for each processing unit the snoop control data in the associated storage element is set based on an indication by operating system software as to which processing units a currently employed process is running on or has been run on.

9. A data processing apparatus as claimed in claim 1, wherein the snoop control data takes the form of a mask comprising a separate bit for each processing unit of the data processing apparatus, for each storage element the mask stored therein being dependent on the process currently being executed by the associated processing unit.

10. A method of managing snoop operations in a data processing apparatus, the data processing apparatus having a plurality of processing units operable to execute a number of processes by performing data processing operations requiring access to data in shared memory, each processing unit having a cache operable to store a subset of said data for access by that processing unit, the method comprising the steps of:
employing a snoop-based cache coherency protocol to ensure data accessed by each processing unit is up-to-date;
for each processing unit storing snoop control data; and
when one of the processing units determines that a snoop operation is required having regard to the cache coherency protocol, referencing the snoop control data for said one of the processing units in order to determine which of the plurality of processing units are to be subjected to the snoop operation.

11. A processing unit for a data processing apparatus in which a plurality of processing units are operable to execute a number of processes by performing data processing operations requiring access to data in shared memory, the processing unit comprising:
a cache operable to store a subset of said data for access by the processing unit, a snoop-based cache coherency protocol being employed to ensure data accessed by each processing unit of the data processing apparatus is up-to-date;
a storage element identifying snoop control data;
whereby when the processing unit determines that a snoop operation is required having regard to the cache coherency protocol, the processing unit is operable to reference the snoop control data in the storage element in order to determine which of the plurality of processing units of the data processing apparatus are to be subjected to the snoop operation.
